(19) United States
(12) Patent Application Publication
(10) Pub. No.: US 2014/0280293 A1
(43) Pub. Date: Sep. 18, 2014

(54) METHOD AND APPARATUS FOR RETRIEVING CACHED DATABASE SEARCH RESULTS

(71) Applicant: MCKESSON FINANCIAL HOLDINGS, Hamilton (BM)

(72) Inventor: Ryan Scanlon, Enfield, CT (US)

(73) Assignee: MCKESSON FINANCIAL HOLDINGS, Hamilton (BM)

(21) Appl. No.: 13/796,520

(22) Filed: Mar. 12, 2013

(51) Int. Cl. G06F 17/30

(52) U.S. Cl. CPC G06F 17/30424
USPC 707/769

(57) ABSTRACT

A method, apparatus and computer program product are provided to efficiently respond to database queries. In the context of a method, a database query is received and a hashed representation of the database query is created. The method also determines whether the hashed representation of the database query serves as a key to a database cache. In an instance in which the hashed representation of the database query is determined to serve as the key to the database cache, the method retrieves database search results from the database cache. Alternatively, in an instance in which the hashed representation of the database query is determined not to serve as the key to the database cache, a search of the database is performed based upon the database query.

### TECHNOLOGICAL FIELD

An example embodiment of the present invention relates generally to the querying of a database and, more particularly, to the retrieval of cached database search results.

### BACKGROUND

Databases frequently store large quantities of data in an organized fashion. Although databases may store a wide variety of different types of data, one example of a database that stores a substantial quantity of data may be a database that stores medical records. Many databases that store data, such as medical records, are updated over the course of time. The updating of a database need not be continuous, but may be performed periodically or at other regular or irregular intervals with the database remaining static between updates.

A database may be queried in order to identify data stored within the database or information regarding the data stored by the database. As such, a database query may return database search results responsive to the query. In this regard, in response to receipt of a database query, the database must be reviewed and data or other information that is responsive to the database query may be provided. The process of responding to a database query therefore consumes both processing time and processing resources. As databases have become larger and queries have become more complex, the time and processing resources required to respond to a query have also generally increased such that it may take longer to receive the database search results and more processing resources may be expended in order to provide the database search results.

Some database queries may be repeated, either by different users seeking the same information or by the same user seeking updated information. In either instance, the database queries that are resubmitted consume additional time and processing resources to generate the database search results each time the database query is posed, regardless of whether the database has been updated since the time at which the same database query was previously processed and, as such, regardless of whether the database search results will be different from those generated in response to the prior instance of the same database query.

### BRIEF SUMMARY

A method, apparatus and computer program product are provided in accordance with an example embodiment in order to more efficiently respond to database queries. In this regard, a method, apparatus and computer program product are provided in accordance with an example embodiment in order to more efficiently utilize the processing time and resources required to respond to database queries. In this regard, the method, apparatus and computer program product may cache the database search results and may then provide the same database search results in an instance in which the same database query is posed at a later point, at least under certain circumstances such as an instance in which the database has not been updated in the time period between the receipt of the database queries. As such, the method, apparatus and computer program product of an example embodiment may provide the database search results in a more timely manner without requiring that the database again be searched so as to conserve processing resources in at least certain circumstances.

In one embodiment, a method is provided that includes receiving a database query and creating, by a processor, a hashed representation of the database query. The method also determines whether the hashed representation of the database query serves as a key to a database cache. In an instance in which the hashed representation of the database query is determined to serve as the key to the database cache, the method retrieves database search results from the database cache. Alternatively, in an instance in which the hashed representation of the database query is determined not to serve as the key to the database cache, a search of the database is performed based upon the database query.

In another embodiment, an apparatus is provided that includes processing circuitry configured to receive a database query and create a hashed representation of the database query. The processing circuitry is also configured to determine whether the hashed representation of the database query serves as a key to a database cache. In an instance in which the hashed representation of the database query is determined to serve as the key to the database cache, the processing circuitry is configured to retrieve database search results from the database cache. However, in an instance in which the hashed representation of the database query is determined not to serve as the key to the database cache, the processing circuitry is configured to perform a search of the database based upon the database query.

In a further embodiment, a computer readable storage medium is provided that includes instructions that, when executed by a processor, cause the processor to receive a database query and to create a hashed representation of the database query. When executed by the processor, the instructions also cause the processor to determine whether the hashed representation of the database query serves as a key to a database cache. In an instance in which the hashed representation of the database query is determined to serve as the key to the database cache, the instructions, when executed by the processor, further cause the processor to retrieve database search results from the database cache. However, in an instance in which the hashed representation of the database query is determined not serve as the key to the database cache, the instructions, when executed by the processor, further cause the processor to perform a search of a database based upon the database query.

In an instance in which the hashed representation of the database query is determined not to serve as the key to the database cache, the method, the processing circuitry of the apparatus and the instructions of the computer readable storage medium of one embodiment may also be configured to store database search results from the search of the database based upon the database query and associate the hashed representation of the database query as the key to the database search results. In an instance in which the hashed representation of the database query is determined not to serve as the key to the database cache, the method, the processing circuitry of the apparatus and the instructions of the computer-readable storage medium of an example embodiment may also be configured to serialize the results of the database query prior to storing the database search results.

However, in an instance in which the hashed representation of the database query is determined to serve as the key to the database cache, the method, the processing circuitry of the apparatus and the instructions of the computer-readable storage medium of one embodiment may also be configured to update a time value identifying a most recent time at which the database search results were retrieved from the database cache. The method, the processing circuitry of the apparatus and the instructions of the computer-readable storage medium of an example embodiment may also be configured to deserialize the database search results in an instance in which the hashed representation of the database query is determined to serve as the key to the database cache. In an instance in which the hashed representation of the database query is determined to serve as the key to the database cache, the method, the processing circuitry of the apparatus and the instructions of the computer-readable storage medium of one embodiment may also be configured to determine whether the database search results are valid prior to providing the database search results, such as by determining whether the database search results are indicated to require a refresh.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a block diagram of an apparatus that may be specifically configured in accordance with an example embodiment of the present invention; and

FIGS. 2-4 are flowcharts illustrating operations performed, such as by the apparatus of FIG. 1, in accordance with example embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The method, apparatus and computer program product of an example embodiment permit a record to be maintained of database queries and the database search results that result from the database queries. Upon the receipt of one of more additional database queries, the method, apparatus and computer program product of an example embodiment may determine if the same database query has been previously processed and, if so, if the database search results that resulted from the prior database query are available and, in one embodiment, remain valid. In such an instance, the method, apparatus and computer program product of an example embodiment may utilize the database search results from the prior database query so as to avoid the processing of redundant database queries in instances in which the database has not been updated since the prior database query was processed. As such, the method, apparatus and computer program product of an example embodiment may increase the efficiency with which database queries are processed, both in terms of the processing time and processing resources required to respond to database queries.

The apparatus 10 of one embodiment may be embodied by a computing device, such as a server or the like. The computing device of one embodiment may be capable of functioning in a health information infrastructure, including desktop or laptop computers, mobile devices, tablet computers, servers, or the like. For example, the apparatus may be configured to provide access to medical records via a user portal. In this regard, the apparatus may be implemented on a computing device that may be configured to receive a patient identity, and to access and display records associated with the patient identity via a display. Additionally or alternatively, the apparatus may be configured to provide a health information system operable to receive and process medical record queries as described herein. The apparatus may be configured to function as a search provider to facilitate the processing of medical record queries and, in some embodiments, to derive analytics for the purpose of providing improved search results.

It should be noted that the components, devices or elements illustrated in and described with respect to FIG. 1 below may not be mandatory and thus some may be omitted in certain embodiments. Additionally, some embodiments may include further or different components, devices or elements beyond those illustrated in and described with respect to FIG. 1.

The apparatus 10 may include or otherwise be in communication with processing circuitry 12 that is configurable to perform actions in accordance with one or more example embodiments disclosed herein. In this regard, the processing circuitry may be configured to perform and/or control performance of one or more functionalities of the apparatus (e.g., functionalities of a computing device on which the apparatus may be implemented) in accordance with various example embodiments, and thus may provide means for performing functionalities of the apparatus (e.g., functionalities of a computing device on which the apparatus may be implemented) in accordance with various example embodiments. The processing circuitry may be configured to perform data processing, application execution and/or other processing and management services according to one or more example embodiments.

In some example embodiments, the processing circuitry 12 may include a processor 14 and, in some embodiments, such as that illustrated in FIG. 1, may further include memory 16. The processing circuitry may be in communication with or otherwise control a user interface 18 and/or a communication interface 20. As such, the processing circuitry may be embodied as a circuit chip (e.g., an integrated circuit chip) configured (e.g., with hardware, software or a combination of hardware and software) to perform operations described herein.

The processor 14 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In some example embodiments, the processor may be configured to execute instructions stored in the memory 16 or otherwise accessible to the processor. As such, whether configured by hardware or by a combination of hardware and software, the processor may represent an entity (e.g., physically embodied in circuitry—in the form of processing circuitry 12) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform one or more operations described herein.

In some example embodiments, the memory 16 may include one or more non-transitory memory devices such as, for example, volatile and/or non-volatile memory that may be either fixed or removable. In this regard, the memory may comprise a non-transitory computer-readable storage medium. The memory may be configured to store information, data, applications, instructions and/or the like for enabling the apparatus 10 to carry out various functions in accordance with one or more example embodiments. For example, the memory may be configured to store instructions for execution by the processor 14. As yet another alternative, the memory may include one or more databases that may store a variety of files, contents or data sets including, for example, a database cache as described below. Among the contents of the memory, applications may be stored for execution by the processor in order to carry out the functionality associated with each respective application. In some cases, the memory may be in communication with one or more of the processor, user interface 18, or communication interface 20 via a bus or buses for passing information among components of the apparatus.

The user interface 18 may be in communication with the processing circuitry 12 to receive an indication of a user input at the user interface and/or to provide an audible, visual, mechanical or other output to the user. As such, the user interface may include, for example, a keyboard, a mouse, a joystick, a display, a touch screen display, a microphone, a speaker, a Light Emitting Diode (LED), a lighting device, an electronic sensor for capturing human body movements, and/or other input/output mechanisms. In embodiments in which the apparatus 10 is implemented on a server, aspects of the user interface may be limited, or the user interface 116 may even be eliminated. For example, the apparatus may act as a server or host device, with a user interface provided by a client application.

The communication interface 20 may include one or more interface mechanisms for enabling communication with other devices and/or networks, such as for supporting communication with a remote database. In some cases, the communication interface may be any means such as a device or circuitry embodied in either hardware, or a combination of hardware and software that is configured to receive and/or transmit data from/to a network and/or any other device or module in communication with the processing circuitry 12, either wirelessly or via a wireline network.

Having described an apparatus 10 configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

The apparatus 10 may be specifically configured in order to perform a plurality of operations, such as illustrated in FIGS. 2-4 in accordance with an example embodiment of the present invention. As shown in block 30 of FIG. 2, the apparatus, such as the processing circuitry 12, the processor 14 or the like, may receive a database query, such as via the communication interface 20, the user interface 18 or the like. For example, a user may enter a database query via a user interface, such as via a keyboard or a touch screen. Various types of database queries may be received including, for example, structured query language (SQL) database queries.

The apparatus 10, such as the processing circuitry 12, the processor 14 or the like, may create a hashed representation of the database query. See block 32 of FIG. 2. In this regard, the database query may be processed in accordance with a hash function in order to produce the hashed representation of the database query. By processing the database query in accordance with the hash function, the resulting hashed representation uniquely identifies the database query relative to other database queries. As described below, the apparatus, such as the processing circuitry, the processor, the memory 16 or the like, may store the hashed representations of prior database queries along with the corresponding database search results that are generated in response to the prior database queries. In particular, the hashed representations of the prior database queries and the corresponding database search results may be stored in a database cache. In this regard, the memory 16 may maintain or include the database cache or the database cache may be separate from the memory, but accessible by the apparatus, such as the processing circuitry. The hashed representations of the prior database queries serve as keys to the corresponding database search results such that a database search result may be uniquely identified based upon the hashed representation of the corresponding database query.

As shown in block 34 of FIG. 2, the apparatus 10, such as the processing circuitry 12, the processor 14 or the like, may also determine whether the hashed representation of the database query that was received serves as a key to a database cache and, more particularly, to database search results stored in the database cache. In an instance in which the hashed representation of the database query serves as a key to the database cache, the same database query was previously processed such that database search results that were generated in response to the prior database query and that may also be responsive to the database query that was recently received may be stored by the database cache. However, a determination that the hashed representation of the database query does not serve as a key to the database cache is an indication that the database query should be processed since the database cache does not include database search results corresponding to the database query, at least not database search results that both correspond to the database query and are valid.

Referring now to FIG. 3, in an instance in which the hashed representation of a database query is determined to serve as a key to the database cache, the apparatus 10, such as the processing circuitry 12, the processor 14 or the like, may retrieve the database search result from the database cache. In this regard, the database search results that correspond to and are associated with the hashed representation of the database query are retrieved from the database cache. For example, the database cache may store one or more database search results with each database search result associated with a hashed representation of the database query that caused the respective database search results to be generated. Thus, the hashed representation of the database query serves as a key to uniquely identify the corresponding database search results generated in response to the database query and stored in the database cache.

In one embodiment, the database search results that are retrieved from the database cache may be provided to the user in response to the database query. See block 48 of FIG. 3. In another embodiment, however, the apparatus 10, such as the processing circuitry 12, the processor 14 or the like, may determine whether the database search results are valid prior to providing the database search results as shown in block 42 of FIG. 3. The validity of the database search results may be determined in various manners.

For example, the apparatus 10, such as the processing circuitry 12, the processor 14 or the like, may be configured to determine whether the database search results that correspond to the hashed representation of the database query are indicated to require a refresh. In an instance in which the database search results are indicated to require a refresh, the database search results may be considered to be invalid. The database search results may be indicated to require refresh for various reasons including the passage of at least a predetermined period of time since the database search results were initially generated. In this regard, the database, such as a database that stores medical records, may be updated on a periodic or other regular or irregular basis. As such, a predefined time period may be defined based upon the manner in which the database is updated. For example, the predefined time period may be the time period at which the database according to which the database is periodically updated. Alternatively, the predefined time period may be a length of time equal to or shorter than the time period for which the database remains unchanged between regular or irregular updates. In order to determine the validity of the database search results, the lapsed time since the generation of the database search result may be compared to the predefined time period with an indication that the database search results require a refresh provided in an instance in which the lapsed time equals or exceeds the predefined time period. Thus, in an instance in which the database search results were generated more than the predefined time period ago, the database search results may be indicated to require refresh since the database may have been updated following the generation of the database search results such that the database search results may no longer be representative of the current contents of the database. In another embodiment, the updating of the database may trigger the setting of an indication associated with each of the database search results in the database cache so as to indicate that the database search results require a refresh regardless of the length of time that has passed since the generation of the database search results since the database has been updated and the database search results may be outdated.

In an instance in which the database search results are valid, the apparatus 10, such as the processing circuitry 12, the processor 14 or the like, may, in one embodiment, update a time value associated with the database search results. In this regard, the time value identifies the most recent time at which the database search results were retrieved from the database cache. Thus, the time value may be updated to the current day and/or time in conjunction with the provision of the database search results from the database cache. See block 44 of FIG. 3. The apparatus, such as the processing circuitry, the processor or the like, may then provide the database search results to the user, such as via the user interface 18, e.g., a display. See block 48 of FIG. 3. In an embodiment described in further detail below, the database search results have been serialized. In this embodiment, the apparatus, such as the processing circuitry, the processor or the like, may deserialize the database search results, such as by deserializing the mark up language, e.g., extensible markup language, bytes that are representative of the database search results, prior to providing the database search results to the user such that the database search results are interpretable by the user. See block 46 of FIG. 3.

In an instance in which the hashed representation the database query is determined not to serve as a key to the database cache, such as in an instance in which the database cache does not include database search results that have been previously generated in response to the database query, or in an instance in which the database search results that is stored by the database cache are determined not to be valid, the database query may be processed so as to generate database search results responsive thereto. As shown in FIG. 4, and more particularly, in block 50 of FIG. 4, the apparatus 10, such as the processing circuitry 12, the processor 14 or the like, may perform a search of the database based upon the database query. As shown in block 60 of FIG. 4, the apparatus, such as the processing circuitry, the processor or the like, may provide the database search results that were generated by the search of the database in response to the database query, such as by providing the database search results to a user via the user interface 18, such as a display.

Either prior to or subsequent to the provision of the database search results, the apparatus 10, such as the processing circuitry 12, the processor 14 or the like, may store the database search results in conjunction with a hashed representation of the corresponding database query in the database cache, such as in the memory 16. See block 56 of FIG. 4. As such, the database search results that are generated by the database query may thereafter be provided in response to the subsequent receipt of the same database query from the same or a different user in an instance in which the prior database search results remain valid, such as in an instance which the database has not yet been updated since the generation of the prior database search results. As such, the method, apparatus and computer program product of this embodiment may respond to a database query without expending the processing time and resources otherwise required to generate the database search results.

As described above in conjunction with block 32 of FIG. 4, the apparatus 10, such as the processing circuitry 12, the processor 14 or the like, may therefore be configured to generate a hashed representation of the database query, such as by subjecting the database query to a hash function. As such, the hashed representation uniquely identifies the database query relative to other database queries. In one embodiment, the apparatus, such as the processing circuitry, the processor or the like, may serialize the results of the database query prior to storing the database search results. See block 54 of FIG. 4. For example, the results of the database query may be serialized into a plurality of markup language, e.g., extensible markup language, bytes.

As shown in block 56, the apparatus 10, such as the processing circuitry 12, the processor 14 or the like, may be configured to store the database search results, such as the serialized results, from the search of the database based upon the database query in the database cache. Additionally, the apparatus, such as the processing circuitry, the processor or the like, may be configured to associate the hashed representation of the database query as a key to the database search results within the database cache. See block 58 of FIG. 4. As such, the database search results may be uniquely identified by and retrieved from the database cache by reference to the hashed representation of the database query. The method, apparatus and computer program product may therefore respond to the subsequent receipt of the same database query by providing the database search results stored by the database cache without having to regenerate the database search results so long as the database search results remain valid. See block 60.

A method, apparatus and computer program product are therefore provided in order to more efficiently respond to database queries. In this regard, a method, apparatus and computer program product are provided to more efficiently utilize the processing time and resources required to respond to database queries. In this regard, the method, apparatus and computer program product may cache the database search results and may then provide the same database search results in an instance in which the same database query is subsequently received, thereby providing the database search results in a more timely manner without requiring that the database again be searched so as to conserve processing resources in at least some circumstances.

It will be understood that each block of the flowcharts of FIGS. 2-4, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 16 of an apparatus 10 employing an embodiment of the present invention and executed by a processor 14 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowchart, can be implemented by special purpose hardware-based computer systems which perform the specified functions, or combinations of special purpose hardware and computer instructions.

In some embodiments, certain ones of the operations above may be modified or further amplified or, alternatively, may be eliminated. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving a database query;
creating, by a processor, a hashed representation of the database query;
determining whether the hashed representation of the database query serves as a key to a database cache;
in an instance in which the hashed representation of the database query is determined to serve as the key to the database cache, retrieving database search results from the database cache; and
in an instance in which the hashed representation of the database query is determined not to serve as the key to the database cache, performing a search of a database based upon the database query.

2. A method according to claim 1 wherein, in an instance in which the hashed representation of the database query is determined not to serve as the key to the database cache, the method further comprises:
storing database search results from the search of the database based upon the database query; and
associating the hashed representation of the database query as a key to the database search results.

3. A method according to claim 2 wherein, in an instance in which the hashed representation of the database query is determined not to serve as the key to the database cache, the method further comprises serializing results of the database query prior to storing the database search results.

4. A method according to claim 1 wherein, in an instance in which the hashed representation of the database query is determined to serve as the key to the database cache, the method further comprising updating a time value identifying a most recent time at which the database search results were retrieved from the database cache.

5. A method according to claim 1 wherein retrieving database search results in an instance in which the hashed representation of the database query is determined to serve as the key to the database cache comprises deserializing the database search results.

6. A method according to claim 1 wherein retrieving database search results in an instance in which the hashed representation of the database query is determined to serve as the key to the database cache comprises determining whether the database search results are valid prior to providing the database search results.

7. A method according to claim 6 wherein determining whether the database search results are valid comprises determining whether the database search results are indicated to require a refresh prior to providing the database search results.

8. An apparatus comprising processing circuitry configured to:
receive a database query;
create a hashed representation of the database query;
determine whether the hashed representation of the database query serves as a key to a database cache;
in an instance in which the hashed representation of the database query is determined to serve as the key to the database cache, retrieve database search results from the database cache; and
in an instance in which the hashed representation of the database query is determined not to serve as the key to the database cache, perform a search of a database based upon the database query.

9. An apparatus according to claim 8 wherein, in an instance in which the hashed representation of the database query is determined not to serve as the key to the database cache, the processing circuitry is further configured to:
store database search results from the search of the database based upon the database query; and
associate the hashed representation of the database query as a key to the database search results.

10. An apparatus according to claim 9 wherein, in an instance in which the hashed representation of the database query is determined not to serve as the key to the database cache, the processing circuitry is further configured to serialize results of the database query prior to storing the database search results.

11. An apparatus according to claim 8 wherein, in an instance in which the hashed representation of the database query is determined to serve as the key to the database cache, the processing circuitry is further configured to update a time value identifying a most recent time at which the database search results were retrieved from the database cache.

12. An apparatus according to claim 8 wherein the processing circuitry is configured to retrieve database search results in an instance in which the hashed representation of the database query is determined to serve as the key to the database cache by deserializing the database search results.

13. An apparatus according to claim 8 wherein the processing circuitry is configured to retrieve database search results in an instance in which the hashed representation of the database query is determined to serve as the key to the database cache by determining whether the database search results are valid prior to providing the database search results.

14. An apparatus according to claim 13 wherein the processing circuitry is configured to determine whether the database search results are valid by determining whether the database search results are indicated to require a refresh prior to providing the database search results.

15. A computer readable storage medium comprising instructions that, when executed by a processor, cause the processor to:
receive a database query;
create a hashed representation of the database query;
determine whether the hashed representation of the database query serves as a key to a database cache;
in an instance in which the hashed representation of the database query is determined to serve as the key to the database cache, retrieve database search results from the database cache; and
in an instance in which the hashed representation of the database query is determined not to serve as the key to the database cache, perform a search of a database based upon the database query.

16. A computer readable storage medium according to claim 15 wherein, in an instance in which the hashed representation of the database query is determined not to serve as the key to the database cache, the instructions, when executed by the processor, further cause the processor to:
store database search results from the search of the database based upon the database query; and
associate the hashed representation of the database query as a key to the database search results.

17. A computer readable storage medium according to claim 16 wherein, in an instance in which the hashed representation of the database query is determined not to serve as the key to the database cache, the instructions, when executed by the processor, further cause the processor to serialize results of the database query prior to storing the database search results.

18. A computer readable storage medium according to claim 15 wherein, in an instance in which the hashed representation of the database query is determined to serve as the key to the database cache, the instructions, when executed by the processor, further cause the processor to update a time value identifying a most recent time at which the database search results were retrieved from the database cache.

19. A computer readable storage medium according to claim 15 wherein the instructions that, when executed by the processor, cause the processor to retrieve database search results in an instance in which the hashed representation of the database query is determined to serve as the key to the database cache comprise instructions that, when executed by the processor, further cause the processor to deserialize the database search results.

20. A computer readable storage medium according to claim 15 wherein the instructions that, when executed by the processor, cause the processor to retrieve database search results in an instance in which the hashed representation of the database query is determined to serve as the key to the database cache comprise instructions that, when executed by the processor, further cause the processor to determine whether the database search results are valid prior to providing the database search results.
